(19) United States
(12) Patent Application Publication
(10) Pub. No.: US 2021/0374827 A1
(43) Pub. Date: Dec. 2, 2021

(54) METHODS AND SYSTEMS FOR DYNAMIC ADJUSTMENT OF A LANDING PAGE

(71) Applicant: Capital One Services, LLC, McLean, VA (US)

(72) Inventors: Micah PRICE, Plano, TX (US); Qiaochu TANG, The Colony, TX (US); Geoffrey DAGLEY, McKinney, TX (US); Avid GHAMSARI, Plano, TX (US)

(73) Assignee: Capital One Services, LLC, McLean, VA (US)

(21) Appl. No.: 16/887,396

(22) Filed: May 29, 2020

(51) Int. Cl. G06Q 30/06; G06F 40/12; G06N 20/00; G06N 5/04

(52) U.S. Cl. CPC G06Q 30/0631; G06N 5/04; G06N 20/00; G06F 40/12

(57) ABSTRACT

A computer-implemented method for dynamically adjusting a landing page with a personalized recommendation to a user may include obtaining first image data of one or more vehicles via a device associated with the user; obtaining second image data of the one or more vehicles based on the first image data, wherein the second image data comprises at least a subset of the one or more images of the one or more vehicles; determining user preference data based on the second image data of the one or more vehicles via a trained machine learning algorithm, wherein the user preference data comprises one or more features of a user-preferred vehicle; determining the personalized recommendation to the user based on the user preference data, wherein the personalized recommendation comprises a personalized webpage showing information related to the user-preferred vehicle; and presenting, to the user, the personalized recommendation.

### TECHNICAL FIELD

Various embodiments of the present disclosure relate generally to providing a landing page displayed on a device, and, more particularly, to dynamically adjusting a landing page displayed on a device associated with a user.

### BACKGROUND

Many electronic devices (e.g., a mobile phone, tablet) may be able to scan items/products (e.g., capture an image of items/products) whenever an owner of the electronic device so chooses. Most scanned images may be used for displaying purposes (e.g., displaying the scanned images to another person), however, often times, no further utilization of scanned images may be considered.

The present disclosure is directed to overcoming the above-referenced challenge. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for dynamically adjusting a landing page with a personalized recommendation to a user based on scanned images. Here, features encompassed/possessed by the item/product in the scanned images may be a signal of a buyer or customer's preference of such features. The landing page may be a webpage or user interface that is first shown to a user when the user opens a browser or an app on a display of the device associated with the user. The methods and systems may utilize the scanned images to dynamically adjust a landing page with a personalized recommendation to a user so that the user can access the information the user prefers efficiently.

In an aspect, a computer-implemented method for dynamically adjusting a landing page with a personalized recommendation to a user may include: obtaining, via one or more processors, first image data of one or more vehicles via a device associated with the user, wherein the first image data includes one or more images of the one or more vehicles acquired by the user via a camera of the device associated with the user; obtaining, via the one or more processors, second image data of the one or more vehicles based on the first image data, wherein the second image data includes at least a subset of the one or more images of the one or more vehicles; determining, via the one or more processors, user preference data based on the second image data of the one or more vehicles via a trained machine learning algorithm, wherein the user preference data includes one or more features of a user-preferred vehicle; determining, via the one or more processors, the personalized recommendation to the user based on the user preference data, wherein the personalized recommendation includes a personalized webpage showing information related to the user-preferred vehicle; and presenting, to the user, the personalized recommendation.

In another aspect, a computer-implemented method for dynamically adjusting a landing page with a personalized recommendation to a user may include: obtaining, via one or more processors, first image data of one or more vehicles via a device associated with the user, wherein the first image data includes one or more images of the one or more vehicles acquired by the user via a camera of the device associated with the user; obtaining, via the one or more processors, geographic data of the one or more vehicles via the device associated with the user, wherein the geographic data is indicative of one or more geographic locations at which the one or more images were acquired by the user via the device associated with the user; obtaining, via the one or more processors, second image data of the one or more vehicles based on the first image data and the geographic data, wherein the second image data includes at least a subset of the one or more images of the one or more vehicles; determining, via the one or more processors, user preference data based on the second image data of the one or more vehicles via a trained machine learning algorithm, wherein the user preference data includes one or more features of a user-preferred vehicle; determining, via the one or more processors, the personalized recommendation to the user based on the user preference data, wherein the personalized recommendation includes a personalized webpage indicative of information related to the user-preferred vehicle; and presenting, to the user, the personalized recommendation.

In yet another aspect, a computer system for dynamically adjusting a landing page with a personalized recommendation to a user may include a memory storing instructions; and one or more processors configured to execute the instructions to perform operations. The operations may include: obtaining first image data of one or more vehicles via a device associated with the user, wherein the first image data includes one or more images of the one or more vehicles acquired by the user via a camera of the device associated with the user; obtaining second image data of the one or more vehicles based on the first image data, wherein the second image data includes at least a subset of the one or more images of the one or more vehicles; determining user preference data based on the second image data of the one or more vehicles via a trained machine learning algorithm, wherein the user preference data includes one or more features of a user-preferred vehicle; determining the personalized recommendation to the user based on the user preference data, wherein the personalized recommendation includes a personalized webpage showing information related to the user-preferred vehicle; and presenting, to the user, the personalized recommendation.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure, according to one or more embodiments.

FIG. 2 depicts a flowchart of an exemplary method of dynamically adjusting a landing page with a personalized recommendation to a user, according to one or more embodiments.

FIG. 3 illustrates an exemplary user interface for demonstrating a landing page with a personalized recommendation to a user, according to one or more embodiments.

FIG. 4 depicts a flowchart of another exemplary method of dynamically adjusting a landing page with a personalized recommendation to a user, according to one or more embodiments.

FIG. 5 depicts an example of a computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

In the following description, embodiments will be described with reference to the accompanying drawings. As will be discussed in more detail below, in various embodiments, data such as first image data, second image data, and/or user preference data, may be used to determine how to dynamically adjust a landing page with a personal recommendation for the user.

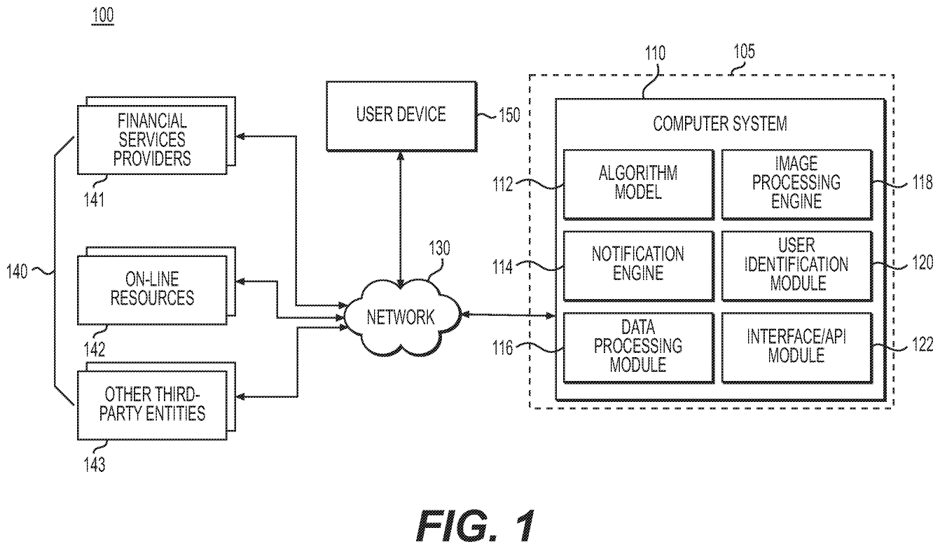

FIG. 1 is a diagram depicting an example of a system environment 100 according to one or more embodiments of the present disclosure. The system environment 100 may include a computer system 110, a network 130, one or more resources for collecting data 140 (e.g., second image data), and a user device (or a device associated with a user) 150. The one or more resources for collecting data 140 may include financial services providers 141, on-line resources 142, or other third-party entities 143. These components may be in communication with one another via network 130.

The computer system 110 may have one or more processors configured to perform methods described in this disclosure. The computer system 110 may include one or more modules, models, or engines. The one or more modules, models, or engines may include an algorithm model 112, a notification engine 114, a data processing module 116, an image processing engine 118, a user identification module 120, and/or an interface/API module 122, which may each be software components stored in the computer system 110. The computer system 110 may be configured to utilize one or more modules, models, or engines when performing various methods described in this disclosure. In some examples, the computer system 110 may have a cloud computing platform with scalable resources for computation and/or data storage, and may run one or more applications on the cloud computing platform to perform various computer-implemented methods described in this disclosure. In some embodiments, some of the one or more modules, models, or engines may be combined to form fewer modules, models, or engines. In some embodiments, some of the one or more modules, models, or engines may be separated into separate, more numerous modules, models, or engines. In some embodiments, some of the one or more modules, models, or engines may be removed while others may be added.

The algorithm model 112 may be a plurality of algorithm models. The algorithm model 112 may include a trained machine learning model. Details of algorithm model 112 are described elsewhere herein. The notification engine 114 may be configured to generate and communicate (e.g., transmit) one or more notifications (e.g., a landing page) to a user device 150 or to one or more resources 140 through the network 130. The data processing module 116 may be configured to monitor, track, clean, process, or standardize data (e.g., user preference data) received by the computer system 110. One or more algorithms may be used to clean, process, or standardize the data. The image processing engine 118 may be configured to monitor, track, clean, process, or standardize image data (e.g., first image data or second image data). The user identification module 120 may manage user identification for each user accessing the computer system 110. In one implementation, the user identification associated with each user may be stored to, and retrieved from, one or more components of data storage associated with the computer system 110 or one or more resources 140. The interface/API module 122 may allow the user to interact with one or more modules, models, or engines of the computer system 110 and may dynamically adjust a landing page shown to a user.

Computer system 110 may be configured to receive data from other components (e.g., one or more resources 140, or user device 150) of the system environment 100 via network 130. Computer system 110 may further be configured to utilize the received data by inputting the received data into the algorithm model 112 to produce a result (e.g., a landing page). Information indicating the result may be transmitted to user device 150 or one or more resources 140 over network 130. In some examples, the computer system 110 may be referred to as a server system that provides a service including providing the information indicating the received data and/or the result to one or more resources 140 or user device 150.

Network 130 may be any suitable network or combination of networks and may support any appropriate protocol suitable for communication of data to and from the computer system 110 and between various other components in the system environment 100. Network 130 may include a public network (e.g., the Internet), a private network (e.g., a network within an organization), or a combination of public and/or private networks. Network 130 may be configured to provide communication between various components depicted in FIG. 1. Network 130 may comprise one or more networks that connect devices and/or components in the network layout to allow communication between the devices and/or components. For example, the network 130 may be implemented as the Internet, a wireless network, a wired network (e.g., Ethernet), a local area network (LAN), a Wide Area Network (WANs), Bluetooth, Near Field Communication (NFC), or any other type of network that provides communications between one or more components of the network layout. In some embodiments, network 130 may be implemented using cell and/or pager networks, satellite, licensed radio, or a combination of licensed and unlicensed radio.

Financial services providers 141 may be an entity such as a bank, credit card issuer, merchant services providers, or other type of financial service entity. In some examples, financial services providers 141 may include one or more merchant services providers that provide merchants with the ability to accept electronic payments, such as payments using credit cards and debit cards. Therefore, financial services providers 141 may collect and store data pertaining to transactions occurring at the merchants. In some embodiments, the financial services providers 141 may provide a platform (e.g., an app on a user device) that a user can interact with. Such user interactions may provide data (e.g., first image data) that may be analyzed or used in the method disclosed herein. The financial services providers 141 may include one or more databases to store any information related to the user or the product (e.g., a vehicle). For instance, vehicle information (e.g., photos, make, or year of a vehicle) may be stored in one or more databases associated with the financial services providers 141.

Online resources 142 may include webpage, e-mail, apps, or social networking sites. Online resources 142 may be provided by manufacturers, vehicle dealers, retailers, consumer promotion agencies, and other entities. For example, online resources 142 may include a webpage that users can access to select, buy, or sell a vehicle. Online resources 142 may include other computer systems, such as web servers, that are accessible by computer system 110.

Other third-party entities 143 may be any entity that is not a financial services provider 141 or online resources 142. For example, other third-party entities 143 may include a merchant. Other third-party entities 143 may include merchants that may each be an entity that provides products. The term “product,” in the context of products offered by a merchant, encompasses both goods and services, as well as products that are a combination of goods and services. A merchant may be, for example, a retailer, a vehicle dealer, a grocery store, an entertainment venue, a service provider, a restaurant, a bar, a non-profit organization, or other type of entity that provides products that a consumer may consume. A merchant may have one or more venues that a consumer may physically visit in order to obtain the products (goods or services) offered by the merchant. In some embodiments, the other third-party entities 143 may provide a platform (e.g., an app on a user device) with which a user can interact. Such user interactions may provide data (e.g., first image data) that may be analyzed or used in the method disclosed herein. The other third-party entities 143 may include one or more databases to store any information related to the user or the product (e.g., a vehicle). For instance, vehicle information (e.g., photos, make, or year of a vehicle) may be stored in one or more databases associated with the other third-party entities 143.

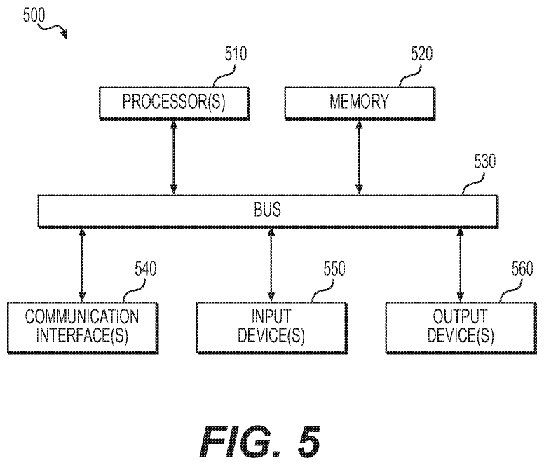

The financial services providers 141, the online resources 142, or any other type of third-party entities 143 may each include one or more computer systems configured to gather, process, transmit, and/or receive data. In general, whenever any of financial services providers 141, the online resources 142, or any other type of third-party entities 143 is described as performing an operation of gathering, processing, transmitting, or receiving data, it is understood that such operations may be performed by a computer system thereof. In general, a computer system may include one or more computing devices, as described in connection with FIG. 5 below.

User device 150 may operate a client program, also referred to as a user application or third-party application, used to communicate with the computer system 110. The client program may be provided by the financial services providers 141, the online resources 142, or any other type of third-party entities 143. This user application may be used to accept user input or provide information (e.g., first image data) to the computer system 110 and to receive information from the computer system 110. The user application may provide the user an access to an imaging device (e.g., a camera) for obtaining first image data. In some examples, the user application may be a mobile application that is run on user device 150. User device 150 may be a mobile device (e.g., smartphone, tablet, pager, personal digital assistant (PDA)), a computer (e.g., laptop computer, desktop computer, server), or a wearable device (e.g., smart watch). User device 150 can also include any other media content player, for example, a set-top box, a television set, a video game system, or any electronic device capable of providing or rendering data. User device 150 may optionally be portable. The user device may be handheld. User device 150 may be a network device capable of connecting to a network, such as network 130, or other networks such as a local area network (LAN), wide area network (WAN) such as the Internet, a telecommunications network, a data network, or any other type of network. The user device 150 may include an imaging device or component that can scan an item/product.

Computer system 110 may be part of an entity 105, which may be any type of company, organization, or institution. In some examples, entity 105 may be a financial services provider. In such examples, the computer system 110 may have access to data pertaining to transactions through a private network within the entity 105. For example, if the entity 105 is a card issuer, entity 105 may collect and store data involving a credit card or debit card issued by the entity 105. In such examples, the computer system 110 may still receive data from other financial services providers 141.

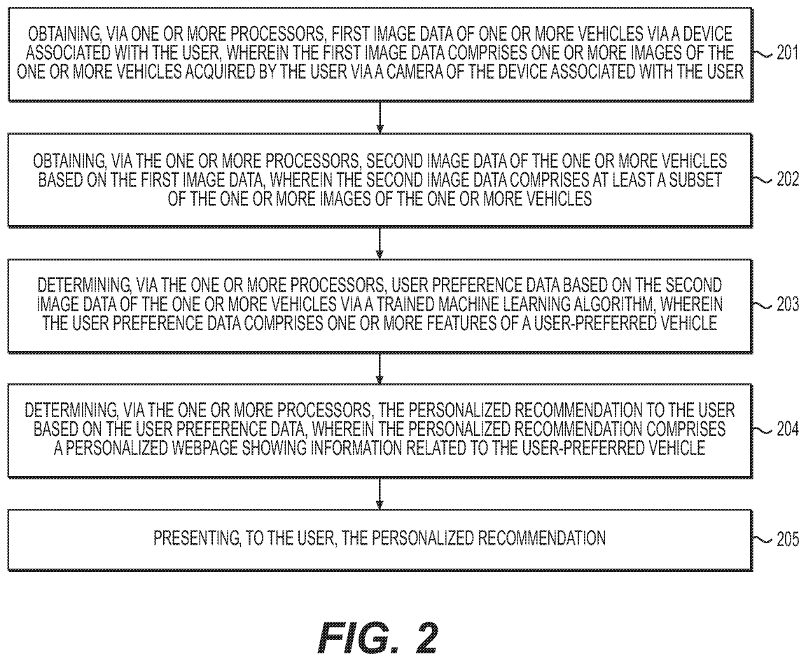

FIG. 2 is a flowchart illustrating a method for dynamically adjusting a landing page with a personalized recommendation to a user, according to one or more embodiments of the present disclosure. The method may be performed by computer system 110.

Step 201 may include a step of obtaining, via one or more processors, first image data of one or more vehicles via a device associated with the user. The first image data may include one or more images or videos of the one or more vehicles acquired by the user via an imaging device of the device associated with the user. The one or more images may include at least one of a front side image, a back side image, a left side image, or a right side image of the one or more vehicles. The one or more images may include an image of the one or more vehicles from an angle. For instance, the image may include an image of the one or more vehicles taken from a 45-degree angle relative to the horizontal plane parallel to the floor. The one or more images may include an enlarged image of a portion of the one or more vehicles. The portion of the one or more vehicles may be any part of the one or more vehicles. In some embodiments, the imaging device may be a camera operably coupled to the device associated with the user (e.g., user device 150). The imaging device or camera can be controlled by an application/software configured to scan an item/product and/or display a scanned image of the item/product. In other embodiments, the imaging device or camera can be controlled by a processor natively embedded in the user device 150. In one example, a user may use a user device 150 including the camera to scan a vehicle that the user observes on the street, and such scanned image of the vehicle may be included in the first image data.

The obtained first image data may be processed and analyzed via the one or more processors. One or more aspects of the quality of the first image data may be analyzed. For instance, one or more aspects may be identified as needing addressing or correction, and may be so addressed and/or corrected by one or more algorithms (e.g., of algorithm model 112). The one or more aspects may include, but are not limited to, inadequate lighting, lack of focus or sharpness, improper alignment of the camera or other imaging device, and image distortion. If the one or more aspects cannot be addressed/corrected, one or more processors may provide guidance or notification to the user via a user interface to obtain additional image data. The first image data may be binarized. For instance, if the first image data is a color or grayscale image, the first image data may be converted into a binary image, in which each pixel may be, for example, black or white. The algorithm to binarize the first image data may include Local Adaptive Niblack Algorithm, Sauvola's Algorithm (e.g., a modification of the Niblack approach useful for images with uneven lighting or a lightly textured background), or any other methods or algorithms for binarizing the first image data. The first image data may further be analyzed for significant skew or misalignment relative to edges or borders. The first image data may then be adjusted or corrected to ensure the image is properly aligned for subsequent processing. Additionally, to process the first image data, one or more transformations (e.g., mathematical transformation functions) may be used to rotate, smooth, or perform contrast reduction of the first image data.

Step 202 may include a step of obtaining, via the one or more processors, second image data of the one or more vehicles based on the first image data. The second image data may include at least a subset of the one or more images of the one or more vehicles. The obtaining the second image data may include aggregating the first image data. Such aggregation may include culling the first image data to remove duplicative image data. The duplicative image data may include a plurality of images of the same vehicle. In some embodiments, the duplicative image data may include identical images (e.g., every information related to two images are the same). In some other embodiments, the duplicative image data may not include identical images, but images taken at the same geographic location for the same vehicle (e.g., images taken at the same geographic location for the same vehicle from different angles). In this situation, the vehicle(s) presented in the duplicative image data can be predicted via one or more algorithms to have the same features (e.g., same make/model), thus are the same vehicle, because the images are taken at the same geographic location. In some other embodiments, the duplicative image data may not include identical images, but images taken at approximately the same time for the same vehicle (e.g., images taken within 2 seconds for the same vehicle from different angles). In this situation, the vehicle(s) presented in the duplicative image data can be predicted via one or more algorithms to have the same features (e.g., same make/model), thus are the same vehicle, because the images are taken at approximately the same time based on timestamps encoded on the images. In some embodiments, the duplicative image data may include identical images, images taken at the same geographic location, and/or images taken at approximately the same time. If images are neither taken at the same geographic location nor taken at approximately the same time, then the images may not be duplicative image data. In one example, a same vehicle may be scanned multiple times via a device associated with the user from different angles or due to a user's mistake (e.g., the user accidently scan the vehicle multiple times), so that first image data may include multiple scanned images of the vehicle. One scanned image of the multiple scanned images may be kept as the second image data. One or more algorithms may be used to obtain the second image data. The one or more algorithms may analyze the first image data to determine which subset of the one or more images of the one or more vehicles is to be kept and which subset of the one or more images to be removed based on one or more criteria, including, for example, whether an image is a duplicate, or whether an image contains one or more aspects needing addressed/corrected. Details of the one or more aspects are described elsewhere herein.

Step 203 may include a step of determining, via the one or more processors, user preference data based on the second image data of the one or more vehicles via a trained machine learning algorithm. The user preference data may include one or more features of a user-preferred vehicle. The user-preferred vehicle may be any vehicle that user likes, is interested in, and/or desires to purchase. The one or more features may include at least one of a make, a model, or a color of the user-preferred vehicle. The one or more features of the user-preferred vehicle may include one or more exterior features and/or one or more interior features of the user-preferred vehicle. The one or more exterior features of the user-preferred vehicle may include at least one of a wheel feature, a color feature, or a shape feature of the user-preferred vehicle. The wheel feature of the user-preferred vehicle may include, for example, the size (e.g., the diameter and width), the brand, the type, the safety level, the rim, the hubcap, or the material of the wheel. The color feature may include any information regarding colors or finishes of the exterior of the user-preferred vehicle. The colors of the user-preferred vehicle may include, by way of example, red, white, blue, black, silver, gold, yellow, orange, pink, green, or gray. The finishes of the exterior of the user-preferred vehicle may include, for example, matte finish, pearlescent finish, metallic finish, or gloss finish. The shape feature of the user-preferred vehicle may include the shape of any portion of the exterior of the user-preferred vehicle, including, the shape of the front side of the user-preferred vehicle, the shape of the flank side of the user-preferred vehicle, or the shape of the back side of the user-preferred vehicle. The one or more exterior features of the user-preferred vehicle may also include any information regarding the user-preferred vehicle, including, but not limited to, vehicle class (e.g., convertible, coupe, sedan, hatchback, sport-utility vehicle, cross-over, minivan, van, or wagon), rear luggage compartment volume, door features (e.g., falcon wing doors, or automatic doors), light features (e.g., color and shape of the tail light), towing capacity (e.g., 4000 lbs. towing limit), mirror features (e.g., shape of the rear mirror, heated side mirrors), sensor and monitor features (e.g., including proximity sensors, humidity sensors, or temperatures sensors), or roof features (e.g., sun roof, moon roof, panoramic roof).

The one or more interior features may be obtained based on a make, a model, or a year of the user-preferred vehicle. The one or more interior features of the user-preferred vehicle may include at least one of a material feature, an electronics feature, an engine feature, or an add-on feature of the user-preferred vehicle. The material feature may include any information regarding the material of the interior of the user-preferred vehicle, including, for example, the material of the seats (e.g., leather, cloth, suede, etc.). The electronics feature may include any information regarding electronics in the user-preferred vehicle, including, for example, audio and multi-media (e.g., in-car internet streaming music and media), internet browser, navigation system, and/or on-board safety or convenience features (e.g., emergency breaking, self-driving, lane assist, or self-parking). The engine feature may include any information regarding the engine of the user-preferred vehicle, including, but not limited to, types of engines (e.g., internal combustion engines, external combustion engines, hybrid engines, or electronic-powered engines), engine layout (e.g., front engine layout), maximum engine speed, max engine power, design and cylinders, valves, drivetrain type (e.g., 4-wheel drive, all-wheel drive, front-wheel drive, or rear-wheel drive), transmission type (e.g., automatic or manual), fuel type (e.g., diesel, electric, gasoline, hybrid, or flex-fuel), or max torque. The add-on feature may include any additional interior features of the user-preferred vehicle, including, seat features (e.g., heated seat, cooled seat), steering wheel features (e.g., heated steering wheel, cooled steering wheel), interior door features (e.g., metal handle), or sun visor feature (e.g., with vanity mirrors). The one or more features may also include any features of the user-preferred vehicle, including, but are not limited to, the performance of the user-preferred vehicle (e.g., track speed, 0-60 mph), the history of the user-preferred vehicle (e.g., years of manufacturing, mileage), service features (e.g., 4 years of warranty), or break features.

In some embodiments, the user preference data may be obtained via the trained machine learning model. The trained machine learning algorithm may include a regression-based model that accepts the first image data and/or the second image data as input data. The trained machine learning algorithm may be part of the algorithm model 112. The trained machine learning algorithm may be of any suitable form, and may include, for example, a neural network. A neural network may be software representing a human neural system (e.g., cognitive system). A neural network may include a series of layers termed “neurons” or “nodes.” A neural network may comprise an input layer, to which data is presented, one or more internal layers, and an output layer. The number of neurons in each layer may be related to the complexity of a problem to be solved. Input neurons may receive data being presented and then transmit the data to the first internal layer through the connections' weight. The trained machine learning algorithm may include a convolutional neural network (CNN), a deep neural network, or a recurrent neural network (RNN).

A CNN may be a deep and feed-forward artificial neural network. A CNN may be applicable to analyzing visual images, such as the first image data or the second image data, described elsewhere herein. Such a convolutional neural network may accept pixel image information and predict a probability of one or more features in a user-preferred vehicle. The higher the probability of a given feature (e.g., a red color), the more likely that the feature may be considered user preference data and/or may appear in a user-preferred vehicle. The user preference data may be updated in real-time and dynamically based on additional first image data or second image data obtained via the device associated with the user (e.g., user device 150). A CNN may include an input layer, an output layer, and multiple hidden layers. Hidden layers of a CNN may include convolutional layers, pooling layers, or normalization layers. Layers may be organized in three dimensions: width, height, and depth. The total number of convolutional layers may be at least about 3, 4, 5, 10, 15, 20 or more. The total number of convolutional layers may be at most about 20, 15, 10, 5, 4, or less.

Convolutional layers may apply a convolution operation to an input and pass results of a convolution operation to a next layer. For processing images, a convolution operation may reduce the number of free parameters, allowing a network to be deeper with fewer parameters. In a convolutional layer, neurons may receive input from only a restricted subarea of a previous layer. A convolutional layer's parameters may comprise a set of learnable filters (or kernels). Learnable filters may have a small receptive field and extend through the full depth of an input volume. During a forward pass, each filter may be convolved across the width and height of an input volume, compute a dot product between entries of a filter and an input, and produce a 2-dimensional activation map of that filter. As a result, a network may learn filters that activate when detecting some specific type of feature at some spatial position as an input.

The user preference data may further include a level of preference of one or more features. In some embodiments, a level of preference of one or more features may be determined via a trained machine learning model. For instance, the higher the probability of a given feature (e.g., a red color), the higher the level of preference of the given feature. In some embodiments, the more frequent that a given feature of the one or more features appears in the second image data, the higher the level of preference of the given feature may be. For instance, the second image data may include a subset of ten scanned images, and all of the ten images may include a vehicle made by Manufacturer A, and five of the ten images include a sedan-type vehicle. In this situation, the level of preference of the Manufacturer A made vehicle may be higher than the level of preference of the sedan-type vehicle. The user-preferred vehicle may be one of the one or more vehicles. The percentage of a given feature of the user-preferred vehicle appearing in the second image data may be above a predetermined percentage threshold. The predetermined percentage threshold may be at least 10%, 20%, 30%, 40%, 50%, 60%, 70%, 80%, 90%, or more. In another embodiment, the predetermined percentage threshold may be at most 90%, 80%, 70%, 60%, 50%, 40%, 30%, 20%, 10%, or less. In one example, among all the images of the second image data, 90% of the images may show a white color vehicle, and a predetermined percentage threshold is 70%, then the user preference data may include a white color vehicle. In another example, among all the images of the second image data, 90% of the images may show a Manufacturer B, Model A vehicle, and a predetermined percentage threshold is 80%, then the user-preferred vehicle may be the Manufacturer B, Model A. In this situation, determining the user preference data may include first determining the user-preferred vehicle and then determining the user preference data by retrieving or extracting vehicle information from the user-preferred vehicle.

Prior to determining the user preference data, or at any stage of dynamically adjusting a landing page with a personalized recommendation to a user, the method may include determining whether the second image data is qualified image data that is usable by the trained machine learning algorithm. Whether the second image data is qualified image data may be determined by a user or one or more algorithms (e.g., of algorithm model 112). The criteria to determine whether the second image data is qualified image data may include whether the second image data contains one or more aspects, including, but not limited to, inadequate lighting, lack of focus or sharpness, improper alignment of the camera or other imaging device, and image distortion. If the second image data is qualified image data, then the second image data may be used to determine the user preference data. If the second image data is not qualified image data, one or more algorithms (e.g., imaging processing algorithms) may be used to update the second image data or provide the user with a notification to obtain new image data. The notification may be displayed in a user interface. In some embodiments, the notification may be configured to be displayed on a display screen of a user device associated with the user (e.g., user device 150). The notification may be displayed on the display screen in any suitable form, such as an e-mail, a text message, a push notification, content on a webpage, and/or any form of graphical user interface. The user device 150 may be capable of accepting inputs of a user via one or more interactive components of the user device 150, such as a keyboard, button, mouse, touchscreen, touchpad, joystick, trackball, camera, microphone, or motion sensor. After the user receives the notification, the user may use the device associated with the user or a camera to take additional first image data.

At any stage of dynamically adjusting a landing page with a personalized recommendation to a user, the method may include determining an interest level of the user to purchase the user-preferred vehicle based on the first image data. One or more algorithms or one or more trigger events may be used to determine the interest level of the user to purchase the user-preferred vehicle. The one or more trigger events may include an indication of repeat or generally consistent interest. For example, the first image data may include multiple images/scans of a same vehicle, and/or the first image data may include multiple images/scans of a same type of vehicle. In some arrangements, the multiple images/scans may be acquired at a same location or multiple locations. Upon acquiring a predetermined number of images/scans of the same vehicle or the same type of vehicle (e.g., upon receiving 6 images/scans of the same vehicle or the same type of vehicle), a required threshold of the trigger event may be considered satisfied. One or more algorithms may aggregate and analyze the first image data to determine which one or more features appear (e.g., within one or more of the received images/scans) more than a predetermined threshold of times within the first image data. For instance, if among all the first image data (e.g., all the scanned images), 90% of them include an SUV-type vehicle, then the user may have a high interest level to purchase an SUV-type vehicle.

Step 204 may include determining, via the one or more processors, the personalized recommendation to the user based on the user preference data. The personalized recommendation may be dynamically updated or adjusted in real-time based on first image data the user acquired. For instance, the personalized recommendation may be different between day 1 and day 3 because additional first image data is received during day 2. The personalized recommendation may include a personalized webpage showing information related to the user-preferred vehicle. The information related to the user-preferred vehicle may include, but is not limited to, one or more images of one or more vehicles similar to the user-preferred vehicle; news or articles related to the user-preferred vehicle; prices, models, makes, years of manufacturing, or mileages of the user-preferred vehicle; any information regarding one or more dealers who sell the user-preferred vehicle (e.g., the names of the dealers, addresses of the dealers, and/or contact information of the dealers); any information regarding purchasing a vehicle by the user (e.g., a recommended location or time to purchase the user-preferred vehicle); upgrade or repair information specific to the user-preferred vehicle; possible substitute or compatible items for the user-preferred vehicle, and so forth. Although a user-preferred vehicle is described herein as an example, the method can be utilized to provide recommendation for other products. The product may be any item or service sold by a merchant. The information related to the user-preferred product/service (e.g., user preferred vehicle) may be presented based on one or more sorting features. The one or more sorting features may include a popularity of certain vehicle, a price of certain vehicle, and/or years of make of certain vehicle.

Step 205 may include presenting, to the user, the personalized recommendation. The personalized recommendation may include, e.g., at least one of a logo, a theme, a color scheme, a slogan, a title screen, or any other output associated with the user preference data or the user-preferred vehicle. Such a personalized recommendation may be presented to the user via a user interface of the device associated with the user (e.g., user device 150). In some embodiments, the step of presenting the personalized recommendation to the user may include receiving such user preference data or the user-preferred vehicle determined in step 203. The personalized recommendation may include, e.g., at least a design, a layout, a graphic scheme, or a color scheme of the personalized recommendation. The design of the personalized recommendation (e.g., a landing page on a user interface) may include a background (e.g., having a shape design, displaying a logo of the user-preferred vehicle, etc.). The layout of the personalized recommendation may include, e.g., an arrangement of texts, graphics, a logo or a theme associated with the user preference data or the user-preferred vehicle. The graphic scheme of the personalized recommendation may include, e.g., a shape or design of a logo or a theme associated with the user preference data or the user-preferred vehicle. The shape of a logo or a theme associated with the user preference data or the user-preferred vehicle may include, e.g., any shape associated with the user preference data or the user-preferred vehicle. The color scheme of the personalized recommendation may include, e.g., any color(s) associated with the background, the logo or the theme associated with the user preference data or the user-preferred vehicle. Such color(s) may include any suitable shade or hue, such as black, white, yellow, red, pink, green, blue, gray, orange, purple, gold, silver, or brown.

At any stage of dynamically adjusting a landing page with a personalized recommendation to a user, the method may further include obtaining identification data of the user, and/or authenticating the user. The authenticating the user may include obtaining the identification data of the user and comparing such the identification data with pre-stored identification data. During the authenticating process, one or more algorithms may be used to compare the identification data with pre-stored identification data and determine whether there is a match (e.g., a complete match or a match equal to or exceeding a predetermined threshold of similarity) between the identification data and the pre-stored identification data. The user may be able to access the app or the platform associated with performing the methods based on whether there is a match (e.g., a complete match or a match equal to or exceeding a predetermined threshold of similarity) between the identification data and the pre-stored identification data. The pre-stored identification may be generated when a device (e.g., a user device 150) is registered or connected with one or more resources 140, computer system 110, or entity 105. Once the pre-stored identification has been generated, it may be stored with other user account information and/or authentication information.

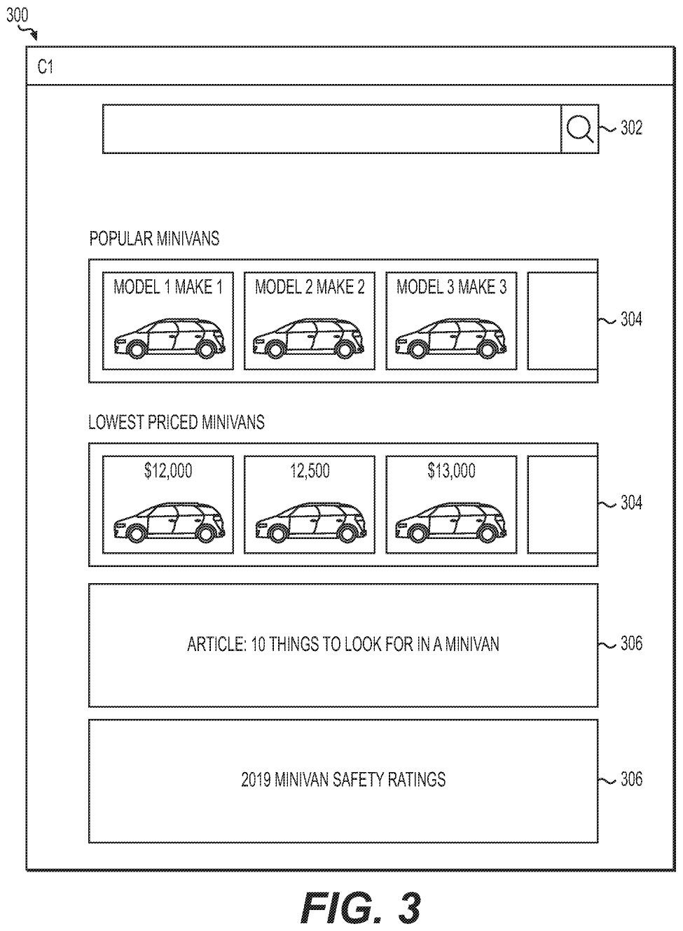

FIG. 3 illustrates a graphic representation of an exemplary landing page or user interface 300 provided on user device 150 of FIG. 1. The landing page or user interface may be associated with software installed on the user device, or may be made available to the user via a website or application. The user can interact with such landing page or user interface 300. In this example, the user device 150 may be a laptop executing software. The landing page or user interface 300 may be displayed to the user after the personalized recommendation is determined. In other embodiments, similar information illustrated in FIG. 3 may be presented in a different format via software executing on an electronic device (e.g., a desktop, mobile phone, or tablet computer) serving as the user device 150.

The landing page or user interface 300 may include one or more windows. The one or more windows may include a search window 302, one or more vehicle presentation windows 304, and/or one or more vehicle information windows 306. At least one of the one or more windows may illustrate a user-preferred vehicle or user preference data. For instance, the one or more vehicle presentation windows 304 may illustrate the vehicles in an order based on the user preference data (e.g., a user-preferred vehicle may be illustrated first). The search window 302 may enable the user to search for a specific vehicle in which the user is interested. The one or more vehicle presentation windows 304 may enable the user to interact with the images of vehicles presented in the one or more vehicle presentation windows 304. A given vehicle presentation window 304 may show the one or more vehicle images based on one or more presentation criteria. The one or more presentation criteria may include popularity (e.g., popular minivans) or prices low-to-high (e.g., lowest priced minivans). The user can interact with one or more vehicle presentation windows 304 to select one or more vehicle images of one or more vehicles. In this example, each image of the one or more vehicle images may demonstrate a specific type of vehicle. Additional information (e.g., the make, the color, or the number of doors) regarding the one or more vehicles may be displayed to the user. The one or more vehicle information windows 306 may enable the user to interact with any information associated with the one or more vehicles, including, for example, news or articles regarding the one or more vehicles (e.g., ten things to look for in a minivan and 2019 minivan safety ratings). The user can interact with one or more vehicle information windows 306 to select any information associated with the one or more vehicles. Additionally, the user interface 300 may include one or more graphical elements, including, but not limited to, input controls (e.g., checkboxes, radio buttons, dropdown lists, list boxes, buttons, toggles, text fields, date field), navigational components (e.g., breadcrumb, slider, search field, pagination, slider, tags, icons), informational components (e.g., tooltips, icons, progress bar, notifications, message boxes, modal windows), or containers (e.g., accordion).

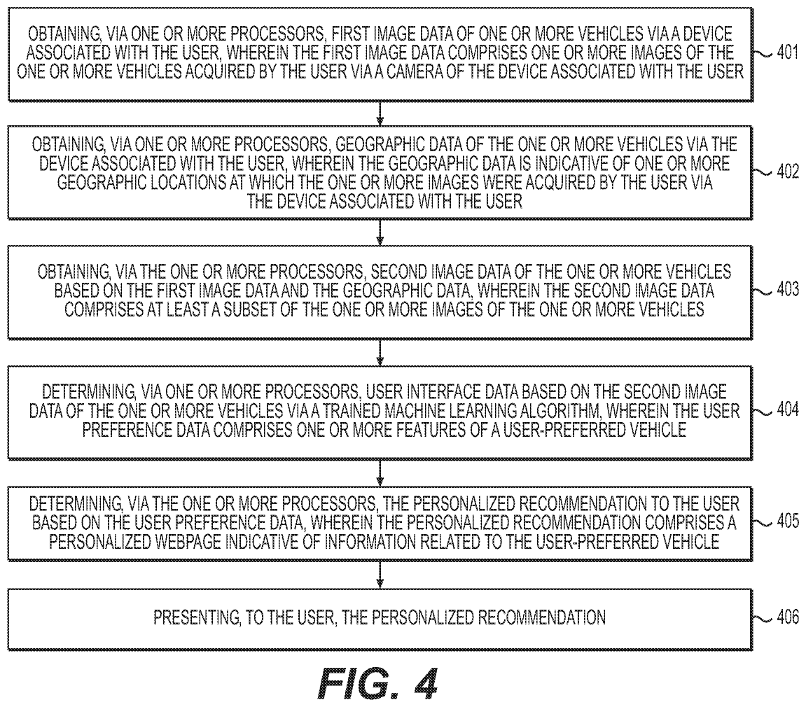

FIG. 4 is a flowchart illustrating another exemplary method for dynamically adjusting a landing page with a personalized recommendation to a user, according to one or more embodiments of the present disclosure. The method may be performed by computer system 110.

Step 401 may include obtaining, via one or more processors, first image data of one or more vehicles via a device associated with the user (e.g., user device 150). The first image data may include one or more images of the one or more vehicles acquired by the user via a camera of the device associated with the user. Details of the first image data and obtaining the first image data are described elsewhere herein.

Step 402 may include obtaining, via the one or more processors, geographic data of the one or more vehicles via the device associated with the user (e.g., user device 150). The geographic data may be indicative of one or more geographic locations at which the one or more images are acquired by the user via the device associated with the user. Such geographic location data may include a specific address at which the one or more images are acquired by the user, or a geographic region surrounding the location at which the one or more images are acquired by the user. In one example, if the location at which the one or more images are acquired by the user is a specific address, the geographic location may be within a region or a radius around the specific address. In this situation, the radius or region may be set by the user or by one or more algorithms. The obtaining the geographic data may include obtaining the geographic data via the first image data, since the geographic data may be embedded into the first image data (e.g., a scanned imaged may contain information indicative of where the image is scanned). The obtaining the geographic data may include identifying the geographic location of the user via a user device associated with the user (e.g., user device 150). The user device 150 may include memory storage that stores a user's geographic data when the first image data is obtained.

Step 403 may include obtaining, via the one or more processors, second image data of the one or more vehicles based on the first image data and the geographic data. The second image data may include at least a subset of the one or more images of the one or more vehicles. The obtaining the second image data may include aggregating the first image data based on the geographic data. Such aggregation may include culling the first image data to remove duplicative image data based on geographic data. For instance, the duplicative image data may include one or more identical images taken at the same geographic location for the same vehicle. In this situation, one of the one or more identical images may be kept and the rest of the one or more identical images may be removed. One or more algorithms may be used to obtain the second image data. The one or more algorithms may analyze the first image data and geographic data to determine which first image data are duplications, which subset of the one or more images of the one or more vehicles to be kept, and which subset of the one or more images to be removed.

Step 404, similarly to step 203, may include determining, via the one or more processors, user preference data based on the second image data of the one or more vehicles via a trained machine learning algorithm. The trained machine learning algorithm may include a convolutional neural network. The user preference data may include one or more features of a user-preferred vehicle. The one or more features may include at least one of a make, a model, or a color of the user-preferred vehicle. The information related to the user-preferred vehicle may include one or more images of the user-preferred vehicle. The user-preferred vehicle may be one of the one or more vehicles contained within the first image data. The user preference data may further include a level of preference of the one or more features. Details of user preference data, the trained machine learning algorithm, one or more features, the user-preferred vehicle, and the level of preference are described elsewhere herein.

Prior to determining the user preference data, or at any stage of dynamically adjusting a landing page with a personalized recommendation to a user, the method may include determining whether the second image data is qualified image data that usable by the trained machine learning algorithm. Whether the second image data is qualified image data may be determined by a user or one or more algorithms. The criteria to determine whether the second image data is qualified image data may include whether the second image data has one or more aspects, including, but not limited to, inadequate lighting, lack of focus or sharpness, improper alignment of the camera or other imaging device, and image distortion. If the second image data is qualified image data, then the second image data can be used to determine the user preference data. If the second image data is not qualified image data, one or more algorithms (e.g., imaging processing algorithms) may be used to update the second image data or provide the user a notification to obtain new image data. The notification may be displayed in a user interface. In some embodiments, the notification may be configured to be displayed on a display screen of a user device associated with the user (e.g., user device 150).

Step 405 may include determining, via the one or more processors, the personalized recommendation to the user based on the user preference data. The personalized recommendation may include a personalized webpage indicative of information related to the user-preferred vehicle. The personalized recommendation may include a personalized webpage showing information related to the user-preferred vehicle. The information related to the user-preferred vehicle may include, but is not limited to, one or more images of the user-preferred vehicle or one or more vehicles similar to the user-preferred vehicle; news or articles related to the user-preferred vehicle; prices, models, makes, years of manufacturing, or mileages of the user-preferred vehicle or one or more vehicles similar to the user-preferred vehicle; any information regarding one or more dealers who sell the user-preferred vehicle or one or more vehicles similar to the user-preferred vehicle (e.g., the names of the dealers, the addresses of the dealers, and/or the contact information for the dealers); any information regarding purchasing the user-preferred vehicle or one or more vehicles similar to the user-preferred vehicle by the user (e.g., a recommended location or time to purchase the user-preferred vehicle); upgrade or repair information specific to the user-preferred vehicle or the one or more vehicles similar to the user-preferred vehicle; possible substitute or compatible items for the user-preferred vehicle, and so forth. Although a vehicle is described herein as an example, the method can be utilized to provide recommendation for other products. The product may be any item or service sold by a merchant. The information related to the user-preferred vehicle may be presented based on one or more presentation criteria. The one or more presentation criteria may include (e.g., popular minivans) or prices low-to-high (e.g., lowest priced minivans). Step 406, similarly to step 205, may include presenting, to the user, the personalized recommendation. Details of the personalized recommendation are described elsewhere herein.

At any stage of dynamically adjusting a landing page with a personalized recommendation to a user, the method may further include obtaining customer image data or customer geographic data of one or more vehicles via a device associated with a customer other than the user. The customer image data may include one or more images or videos of the one or more vehicles acquired by the customer other than the user via an imaging device of the device associated with the customer. Details of the one or more images or imaging device are described elsewhere herein. In one example, a customer other than the user may use a device including the camera to scan a vehicle that the customer other than the user observes, and such a scanned image of the vehicle may be included in the customer image data.

At any stage of dynamically adjusting a landing page with a personalized recommendation to a user, the method may further include determining a trend of purchasing the one or more vehicles based on the customer image data and the customer geographic data. The customer image data may be analyzed, binarized, aggregated, or further processed before being used to determine a trend of purchasing the one or more vehicles. The customer image data or customer geographic data may be used to determine a trend of purchasing the one or more vehicles in a certain geographic location. For instance, customer image data may indicate a frequency that a certain type of vehicle is scanned by customers other than the user, and the higher the frequency the certain type of vehicle is scanned, the more popular (e.g., more trendy) the certain type of vehicle may be considered within a geographic area. The customer geographic data may be used to determine the trend of purchasing the one or more vehicles within a specific geographic area (e.g., images of a vehicle scanned at a specific location may indicate the vehicle is trendy at the specific location) and/or aggregate (e.g., cull) the customer image data to remove duplicative image data since the duplicative image data may include images taken at the same geographic location for the same vehicle.

The trend of purchasing the one or more vehicles based on the customer image data and the customer geographic data may also be determined via a trained machine learning algorithm. The trained machine learning algorithm may compute the trend of purchasing the one or more vehicles as a function of the first image data, the second image data, the user preference data, the customer image data, or one or more variables indicated in the input data. The one or more variables may be derived from the first image data, the second image data, the user preference data, and/or the customer image data. This function may be learned by training the machine learning algorithm with training sets.

The machine learning algorithm may be trained by supervised, unsupervised, or semi-supervised learning using training sets comprising data of types similar to the type of data used as the model input. For example, the training set used to train the model may include any combination of the following: the first image data obtained by the device associated with the user, the second image data, the user preference data, the personalized recommendation for the user, the customer image data obtained by the device associated with the customer other than the user, the customer geographic data, the customer preference data, the personalized recommendation for the customers other than the user, and the trend of purchasing one or more vehicles. Additionally, the training set used to train the model may further include user/customer data, including, but not limited to, demographic information of the user or the customer, or other data related to the user or the customer. Accordingly, the machine learning model may be trained to map input variables to a quantity or value of the personalized recommendation to the user or the trend of purchasing one or more vehicles. That is, the machine learning model may be trained to determine a quantity or value of the personalized recommendation to the user or the trend of purchasing one or more vehicles as a function of various input variables.

At any stage of dynamically adjusting a landing page with a personalized recommendation to a user, the method may further include storing the first image data, the second image data, the user preference data, the geographic data, the customer image data, the customer geographic data, the personalized recommendation, or the trend of purchasing one or more vehicles for subsequent analysis. The stored data may have an expiration period. The expiration period may be at least 1 day, 1 week, 1 month, 1 quarter, 1 year, or longer. In other embodiments, the expiration period may be at most 1 year, 1 quarter, 1 month, 1 week, 1 day, or shorter. The subsequent analysis may include analyzing the personalized recommendation or the trend of purchasing one or more vehicles to update the first image data, the second image data, the user preference data, the geographic data, the customer image data, and the customer geographic data. The stored data may also be one of the one or more variables used in training a trained machine learning model. Details of the trained machine learning model are described elsewhere herein.

The method disclosed herein may dynamically adjust a landing page with a personal (e.g., individual user-specific) recommendation based on one or more vehicle images scanned via a user device instead of, or in conjunction with, a search history browsed by a user. The method disclosed herein may aggregate image data from the one or more vehicle images, and determine a customer's or a user's preference for a specific type of vehicle or feature of vehicle. As such, customers or users who initially may be unsure of which types of vehicles they are interested in (e.g., a customer may know a specific make and/or model of interest, but may be unsure which features such as color, price, or year range they prefer), may utilize the methods disclosed herein to determine one or more user-preferred vehicles that customers or users may be interested in. The obtaining the one or more vehicle images and dynamically adjusting a landing page may happen simultaneously or within a period of time (e.g., less than 1 second, less than 5 minutes). The process of obtaining the one or more vehicle images and the process of dynamically adjusting a landing page may be performed in different channels. For instance, the one or more vehicle images may be first scanned via a first application on a user device and then may be used to dynamically adjust a landing page presented in a second application on a user device.

In general, any process discussed in this disclosure that is understood to be computer-implementable, such as the processes illustrated in FIGS. 2 and 4, may be performed by one or more processors of a computer system, such as computer system 110, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable type of processing unit.

A computer system, such as computer system 110 and/or user device 150, may include one or more computing devices. If the one or more processors of the computer system 110 and/or user device 150 are implemented as a plurality of processors, the plurality of processors may be included in a single computing device or distributed among a plurality of computing devices. If computer system 110 and/or user device 150 comprises a plurality of computing devices, the memory of the computer system 110 may include the respective memory of each computing device of the plurality of computing devices.

FIG. 5 illustrates an example of a computing device 500 of a computer system, such as computer system 110 and/or user device 150. The computing device 500 may include processor(s) 510 (e.g., CPU, GPU, or other such processing unit(s)), a memory 520, and communication interface(s) 540 (e.g., a network interface) to communicate with other devices. Memory 520 may include volatile memory, such as RAM, and/or non-volatile memory, such as ROM and storage media. Examples of storage media include solid-state storage media (e.g., solid state drives and/or removable flash memory), optical storage media (e.g., optical discs), and/or magnetic storage media (e.g., hard disk drives). The aforementioned instructions (e.g., software or computer-readable code) may be stored in any volatile and/or non-volatile memory component of memory 520. The computing device 500 may, in some embodiments, further include input device(s) 550 (e.g., a keyboard, mouse, or touchscreen) and output device(s) 560 (e.g., a display, printer). The aforementioned elements of the computing device 500 may be connected to one another through a bus 530, which represents one or more busses. In some embodiments, the processor(s) 510 of the computing device 500 includes both a CPU and a GPU.

Instructions executable by one or more processors may be stored on a non-transitory computer-readable medium. Therefore, whenever a computer-implemented method is described in this disclosure, this disclosure shall also be understood as describing a non-transitory computer-readable medium storing instructions that, when executed by one or more processors, cause the one or more processors to perform the computer-implemented method. Examples of non-transitory computer-readable medium include RAM, ROM, solid-state storage media (e.g., solid state drives), optical storage media (e.g., optical discs), and magnetic storage media (e.g., hard disk drives). A non-transitory computer-readable medium may be part of the memory of a computer system or separate from any computer system.

It should be appreciated that in the above description of exemplary embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the disclosure, and it is intended to claim all such changes and modifications as falling within the scope of the disclosure. For example, functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted.

What is claimed is:

1. A computer-implemented method for dynamically adjusting a landing page with a personalized recommendation to a user, the method comprising:
obtaining, via one or more processors, first image data of one or more vehicles via a device associated with the user, wherein the first image data comprises one or more images of the one or more vehicles acquired by the user via a camera of the device associated with the user;
obtaining, via the one or more processors, second image data of the one or more vehicles based on the first image data, wherein the second image data comprises at least a subset of the one or more images of the one or more vehicles;
determining, via the one or more processors, user preference data based on the second image data of the one or more vehicles via a trained machine learning algorithm, wherein the user preference data comprises one or more features of a user-preferred vehicle;
determining, via the one or more processors, the personalized recommendation to the user based on the user preference data, wherein the personalized recommendation comprises a personalized webpage showing information related to the user-preferred vehicle; and
presenting, to the user, the personalized recommendation.

2. The method of claim 1, wherein the information related to the user-preferred vehicle includes one or more images of the user-preferred vehicle.

3. The method of claim 1, wherein the obtaining the second image data includes culling the first image data to remove duplicative image data.

4. The method of claim 1, further including, prior to determining the user preference data, determining whether the second image data is qualified image data that usable by the trained machine learning algorithm.

5. The method of claim 1, wherein the trained machine learning algorithm includes a convolutional neural network.

6. The method of claim 1, wherein the one or more features include at least one of a make, a model, or a color of the user-preferred vehicle.

7. The method of claim 1, wherein the user preference data further includes a level of preference of one or more features.

8. The method of claim 1, wherein the user-preferred vehicle is one of the one or more vehicles.

9. The method of claim 1, further including determining an interest level of the user to purchase the user-preferred vehicle based on the first image data.

10. A computer-implemented method for dynamically adjusting a landing page with a personalized recommendation to a user, the method comprising:
obtaining, via one or more processors, first image data of one or more vehicles via a device associated with the user, wherein the first image data comprises one or more images of the one or more vehicles acquired by the user via a camera of the device associated with the user;
obtaining, via the one or more processors, geographic data of the one or more vehicles via the device associated with the user, wherein the geographic data is indicative of one or more geographic locations at which the one or more images were acquired by the user via the device associated with the user;
obtaining, via the one or more processors, second image data of the one or more vehicles based on the first image data and the geographic data, wherein the second image data comprises at least a subset of the one or more images of the one or more vehicles;
determining, via the one or more processors, user preference data based on the second image data of the one or more vehicles via a trained machine learning algorithm, wherein the user preference data comprises one or more features of a user-preferred vehicle;
determining, via the one or more processors, the personalized recommendation to the user based on the user preference data, wherein the personalized recommendation comprises a personalized webpage indicative of information related to the user-preferred vehicle; and
presenting, to the user, the personalized recommendation.

11. The method of claim 10, wherein the information related to the user-preferred vehicle includes one or more images of the user-preferred vehicle.

12. The method of claim 10, wherein the obtaining the second image data includes culling the first image data to remove duplicative image data.

13. The method of claim 10, further including, prior to determining the user preference data, determining whether the second image data is qualified image data usable by the trained machine learning algorithm.

14. The method of claim 10, wherein the trained machine learning algorithm includes a convolutional neural network.

15. The method of claim 10, wherein the one or more features includes at least one of a make, a model, or a color of the user-preferred vehicle.

16. The method of claim 10, wherein the user preference data further includes a level of preference of the one or more features.

17. The method of claim 10, wherein the user-preferred vehicle is one of the one or more vehicles.

18. The method of claim 10, further including obtaining customer image data or customer geographic data of one or more vehicles via a device associated with a customer other than the user.

19. The method of claim 18, further including determining a trend of purchasing the one or more vehicles based on the customer image data and the customer geographic data.

20. A computer system for dynamically adjusting a landing page with a personalized recommendation to a user:
a memory storing instructions; and
one or more processors configured to execute the instructions to perform operations including:
obtaining first image data of one or more vehicles via a device associated with the user, wherein the first image data comprises one or more images of the one or more vehicles acquired by the user via a camera of the device associated with the user;
obtaining second image data of the one or more vehicles based on the first image data, wherein the second image data comprises at least a subset of the one or more images of the one or more vehicles;
determining user preference data based on the second image data of the one or more vehicles via a trained machine learning algorithm, wherein the user preference data comprises one or more features of a user-preferred vehicle;
determining the personalized recommendation to the user based on the user preference data, wherein the personalized recommendation comprises a personalized webpage showing information related to the user-preferred vehicle; and
presenting, to the user, the personalized recommendation.
